(19) United States
(12) Patent Application Publication
(10) Pub. No.: US 2014/0144276 A1
(43) Pub. Date: May 29, 2014

(54) PARALLEL MANIPULATOR

(71) Applicant: Guk Jin YANG, Yongin (KR)

(72) Inventor: Guk Jin YANG, Yongin (KR)

(21) Appl. No.: 14/088,394

(22) Filed: Nov. 23, 2013

(30) Foreign Application Priority Data
Nov. 26, 2012 (KR) 10-2012-0134592

(51) Int. Cl. B25J 9/00

(52) U.S. Cl. CPC B25J 9/003
USPC 74/490.03

(57) ABSTRACT

A parallel manipulator is provided. The parallel manipulator includes a plurality of motor devices separately arranged at predetermined separation distances, a plurality of connection members configured to couple the plurality of motor devices to each other, a plurality of robot arms coupled respectively to the plurality of motor devices, and a movable member coupled to ends of the robot arms.

### CROSS-REFERENCE TO RELATED APPLICATION

This application claims priority to and the benefit of Korean Patent Application No. 10-2012-0134592, filed Nov. 26, 2012, the disclosure of which is incorporated herein by reference in its entirety.

### BACKGROUND

1. Field of the Invention

The present invention relates to a parallel manipulator and, more particularly, to a parallel manipulator capable of being properly installed according to working environments so as to actively cope with changes in working areas and minimizing a load applied to drive modules.

2. Discussion of Related Art

A parallel manipulator is an apparatus that is used in the field of precision industries such as semiconductor industry, electronic parts, etc. In general, the parallel manipulator serves to move an object from space A to space B. As shown in FIG. 1, a conventional parallel manipulator 10 is configured to couple an object to a movable member 14 and then move the object using a plurality of robot arms 23 and the movable member 14 attached to an end of one of the robot arms 23. Drive units 12 are coupled respectively to the plurality of robot arms 23. Each of the drive units 12 includes motor devices to correspond to the robot arms 13, respectively. Each of the motor devices includes a motor and a gear module.

Such a parallel manipulator 10 is manufactured with a uniform shape for the purpose of mass production. In this case, the parallel manipulator 10 is widely used for various types of movable works, depending on the characteristics of users' workshops. The robot arms 23 are formed of a metal or a carbon fiber, and a load which has been produced by movement of the robot arms 23, the movable members 14 and workpieces coupled to the movable members 14 is entirely applied to motors of the drive units 12.

As described above, the conventional parallel manipulator 10 has a problem in that it is not properly installed due to its uniform shape, depending on various types of users' working environments.

One example of technology associated with the present invention is Korean Patent Application No. 10-2011-0054463.

### SUMMARY OF THE INVENTION

The present invention is designed to solve the problems of the prior art, and therefore it is an object of the present invention to provide a parallel manipulator capable of being installed in a custom-made manner according to the users' working environments.

It is another object of the present invention to provide a parallel manipulator capable of minimizing a load since a movable member is allowed to move without departing to a great extent from an arrangement area of motor devices.

One aspect of the present invention provides a parallel manipulator including:

a plurality of motor devices 21 separately arranged at predetermined separation distances;

a plurality of connection members 22 configured to couple the plurality of motor devices 21 to each other;

a plurality of robot arms 23 coupled respectively to the plurality of motor devices 21; and

a movable member 24 coupled to ends of the robot arms 23.

Also, the parallel manipulator is characterized in that each of the connection members 22 includes:

a first guide member 221; and

a second guide member 222 guidably coupled to the first guide member 221.

In addition, the parallel manipulator is characterized in that:

the first guide member 221 has a plurality of first guide member holes 2211 formed thereof at a constant distance,

the second guide member 222 has a plurality of second guide member holes 2221 formed thereof, and

the first guide member 221 and the second guide member 222 are guidably coupled to each other in a state in which positions of the second guide member holes 2221 correspond to positions of the first guide member holes 2211, respectively, and fixture members 223 are then coupled through the first guide member holes 2211 and the second guide member holes 2221.

### BRIEF DESCRIPTION OF THE DRAWINGS

The above and other objects, features and advantages of the present invention will become more apparent to those of ordinary skill in the art by describing in detail exemplary embodiments thereof with reference to the attached drawing, in which:

FIG. 1 is a perspective view showing a conventional parallel manipulator;

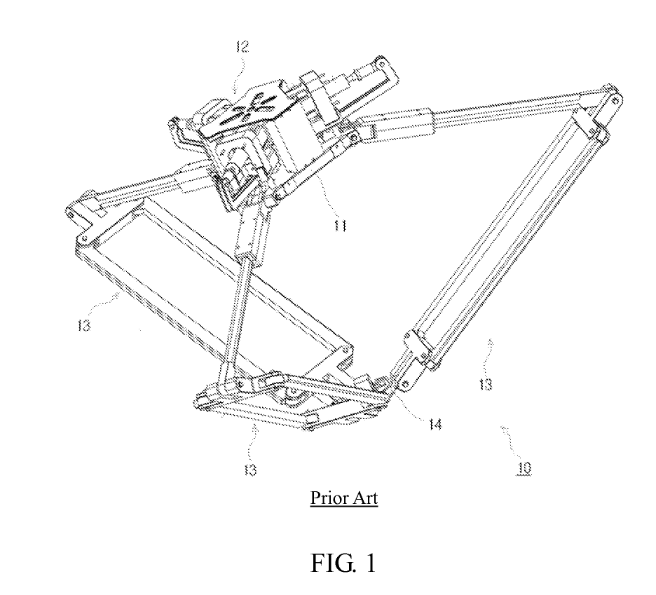

FIG. 2 is a perspective view showing a parallel manipulator according to one exemplary embodiment of the present invention;

FIG. 3 is a top view showing the parallel manipulator according to one exemplary embodiment of the present invention; and

FIG. 4 is an exploded perspective view showing a connection member of the parallel manipulator according to one exemplary embodiment of the present invention.

### DETAILED DESCRIPTION OF EXEMPLARY EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof

With reference to the appended drawings, exemplary embodiments of the present invention will be described in detail below. To aid in understanding the present invention, like numbers refer to like elements throughout the description of the figures, and the description of the same elements will be not reiterated.

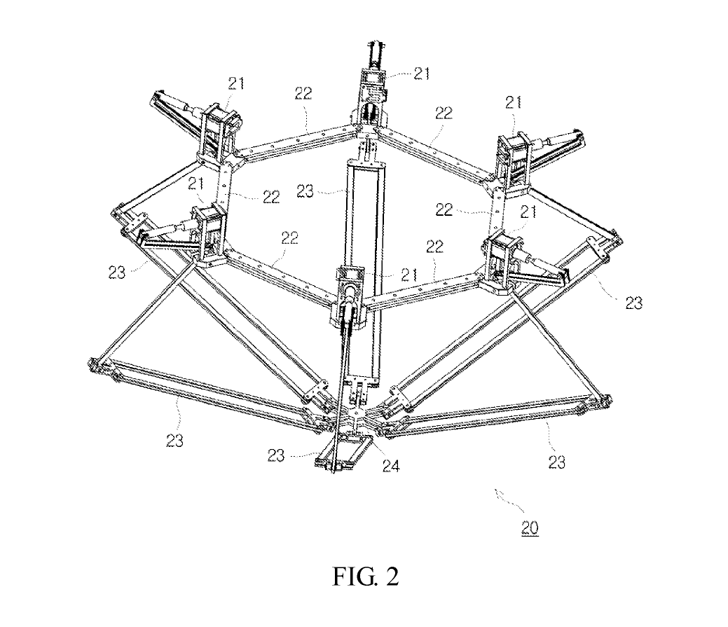

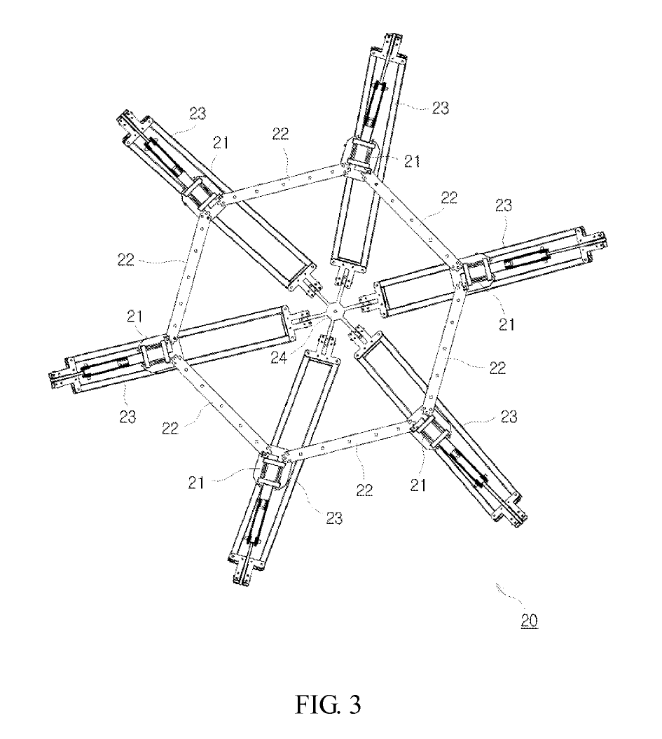

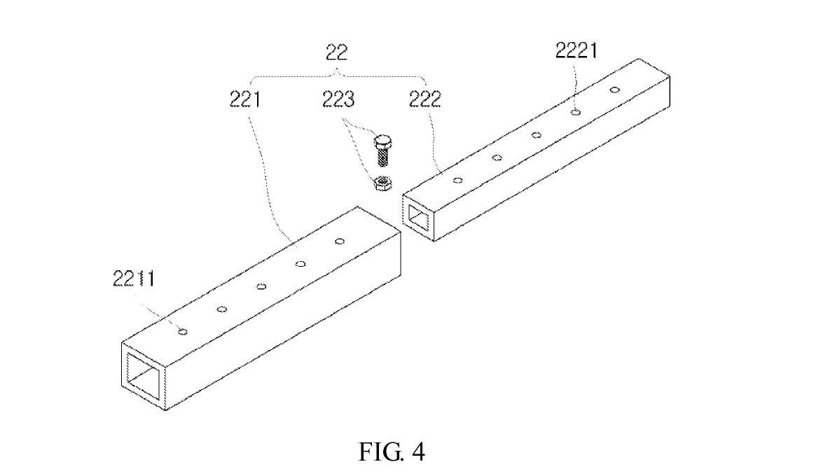

FIG. 2 is a perspective view showing a parallel manipulator according to one exemplary embodiment of the present invention, FIG. 3 is a top view showing the parallel manipulator according to one exemplary embodiment of the present invention, and FIG. 4 is an exploded perspective view showing a connection member of the parallel manipulator according to one exemplary embodiment of the present invention.

A parallel manipulator 20 according to this exemplary embodiment includes a plurality of motor devices 21 separately arranged at predetermined separation distances, a plurality of connection members 22 configured to couple the plurality of motor devices 21 to each other; a plurality of robot arms 23 coupled respectively to the plurality of motor devices 21; and a movable member 24 coupled to ends of the robot arms 23.

The parallel manipulator 20 according to this exemplary embodiment is a robot system widely used in industrial fields to carry an object. The parallel manipulator 20 may operate to accurately move an object attached to the movable member 24 under the systematic control of a plurality of motor devices 21.

The motor devices 21 are arranged at spots corresponding to vertexes of a polygon. According to this exemplary embodiment, six motor devices 21 are arranged at positions corresponding to the vertexes of a regular hexagon, as shown in FIG. 2. In this case, three, four and five motor devices may be arranged at positions corresponding to the vertexes of a triangle, a tetragon and a pentagon, respectively. At least six motor devices may also be arranged at positions corresponding to the vertexes of the corresponding polygons. When there are too many motor devices 21, a load is dissipated toward the respective motor devices 21, thereby enabling the parallel manipulator 20 to durably operate in a stable and smooth manner. According to this exemplary embodiment, the motor devices 21 are arranged in a regular hexagonal shape, but may be arranged in a slightly modified hexagonal shape according to the characteristics of a working space. In addition, various changes and modifications may be made to the motor devices 21, depending on the users' working environments.

Each of the motor devices 21 includes a motor and a gear module.

The plurality of motor devices 21 are coupled to each other by the connection members 22, respectively. In this case, the motor devices 21 may be firmly coupled to each other by the connection members 22 without any swinging motion. Here, it is important to firmly couple the motor devices 21 in order to perform precise operations without any error.

Each of the connection members 22 includes a first guide member 221, and a second guide member 222 guidably coupled to the first guide member 221. It is possible to adjust the lengths of the connection members 22 according to the positions of the first guide member 221 and the second guide member 222 which are are guidably coupled to each other. Therefore, the separation distances between the motor devices 21 may be adjusted according to various types of working environments.

First guide member holes 2211 are formed at a constant distance in the first guide member 221, and second guide member holes 2221 are formed in the second guide member 222. Also, the first guide member 221 and the second guide member 222 are guidably coupled to each other in a state in which the positions of the second guide member holes 2221 correspond to the positions of the first guide member holes 2211, respectively, and fixture members 223 are then coupled and firmly fixed through the first guide member holes 2211 and the second guide member holes 2221. The fixture members 223 may be bolts and nuts.

The robot arms 23 are coupled to the plurality of motor devices 21, respectively. Each of the robot arms 23 is formed in a multi-stage joint structure. Since the robot arms 23 are made of a metal, the robot arms 23 are very heavy in weight. The movable member 24 is coupled to ends of the robot arms 23. An object to be processed is coupled to the movable member 24, and allowed to move along with the movable member 24.

As shown in the top view of FIG. 3, the lengths of the connection members 22 may be adjusted to adjust a hexagonal shape. Also, the arrangements of the motor devices 21 may be widely altered to form a traffic line inside a hexagonal structure of the movable member 24. As a result, a load applied to each of the motor devices 21 may be dissipated by properly adjusting the load applied to each of the motor devices 21 according to the position of the movable member 24.

For example, when the movable member 24 is positioned adjacent to some of the motor devices 21, a significant amount of the load may be applied to the corresponding motor devices, but a suitable amount of the load to support the other motor devices remote from the movable member 24 may be applied to the corresponding motor devices. As a result, operations may continue to be repeatedly performed as long as an excessive amount of the load is prevented from being applied to the motor devices. Especially, the parallel manipulator 20 according to this exemplary embodiment has an advantage in that it can be installed in a custom-made manner according to the users' working environments.

Meanwhile, since the connection members 22 does not have a guide structure but is integrally formed as one member, the connection members 22 may also be cut and used upon installation. Also, the connection members 22 may be prepared as subsidiary materials having various lengths, and may be installed according to the working environments. The connection members 22 may be configured to diagonally couple the motor devices 21 across an inner part of the polygonal structure.

As described above, the parallel manipulator 20 may be manufactured in a custom-made manner to have various sizes and shapes by adjusting the lengths of the connection members 22 according to the users' working environments.

According to the prior art, as the movable member gets remote from the motor devices, an excessive amount of a load may also be inevitably applied to all the motor devices. According to this exemplary embodiment, however, since the positions of the motor devices may be adjusted according to the working environments, an optimal load may be applied to some of the motor devices, so that an unreasonable amount of the load cannot be applied to the other motor devices.

According to the prior art, a high-power and high-specification motor is used to drive a parallel manipulator according to various types of working environments. According to this exemplary embodiment, however, the sizes and specifications of the parallel manipulator 20 may be adjusted by adjusting the lengths of the connection members 22 according to the working environments.

In addition, the connection members 22 of the parallel manipulator 20 according to this exemplary embodiment may be configured to couple the motor devices which are remotely positioned across the inner part of the hexagonal structure.

The present invention provides a parallel manipulator capable of being installed in a custom-made manner according to the users' working environments.

Also, the present invention provides a parallel manipulator capable of minimizing a load since a movable member is allowed to move without departing to a great extent from an arrangement area of motor devices.

While the invention has been shown and described with reference to certain exemplary embodiments thereof, it will be understood by those skilled in the art that various changes in form and details may be made therein without departing from the scope of the invention as defined by the appended claims.

What is claimed is:

1. A parallel manipulator comprising:
a plurality of motor devices separately arranged at predetermined separation distances;
a plurality of connection members configured to couple the plurality of motor devices to each other;
a plurality of robot arms coupled respectively to the plurality of motor devices; and
a movable member coupled to ends of the robot arms.

2. The parallel manipulator according to claim 1, wherein each of the connection members comprises:
a first guide member; and
a second guide member guidably coupled to the first guide member.

3. The parallel manipulator according to claim 2, wherein the first guide member has a plurality of first guide member holes formed thereof at a constant distance,
the second guide member has a plurality of second guide member holes formed thereof, and
the first guide member and the second guide member are guidably coupled to each other in a state in which positions of the second guide member holes correspond to positions of the first guide member holes, respectively, and fixture members are then coupled through the first guide member holes and the second guide member holes.
